(19) United States
(12) Patent Application Publication
(10) Pub. No.: US 2013/0220765 A1
(43) Pub. Date: Aug. 29, 2013

(54) CLUTCH

(71) Applicant: Friedrich Faust, Dortmund (DE)

(72) Inventor: Friedrich Faust, Dortmund (DE)

(73) Assignee: Maschinenfabrik Möninghoff GmbH & Co. KG, Bochum (DE)

(21) Appl. No.: 13/808,832

(22) PCT Filed: Mar. 31, 2011
(86) PCT No.: PCT/DE2011/000349

§ 371 Date: Jan. 24, 2013

(30) Foreign Application Priority Data
Jul. 12, 2010 (DE) 10 2010 026 942.5

(51) Int. Cl. F16D 11/14

(52) U.S. Cl. CPC F16D 11/14
USPC 192/69.81

(57) ABSTRACT

A clutch which can be incorporated into a rotating drive train between a driving part and driven part includes a locally fixable coil housing with an integrated electromagnet coil, a positioning unit which is mounted rotatably in the coil housing and can be connected to the driving part and has an inner, two-stage, saw-tooth-like retaining toothing and a saw-tooth-like actuating toothing frontally opposite the latter, an axially displaceable coupling unit which is actuated under the influence of the electromagnet coil and of a resilient restoring force and has an incorporated, rotatable thrust ring including two saw-tooth-like serrations, and driven flange which can be coupled to the coupling unit via crown toothings on the end side and can be connected to the driven part.

The invention relates to a clutch which is incorporable between a driving part and a driven part, according to the features of the preamble of claim 1.

A clutch in a rotating drive train serves for generating or interrupting a torque transmission from a driving part to a driven part (for example from a driving machine to a working machine). For this, an external supply of energy is required for the coupling motion as well as for the subsequent releasing or closing holding of the clutch. This is associated with relatively high energy consumption and as a result also with corresponding energy costs, in particular when the clutch requires electric energy.

From the state of the art, DE 601 24 478 T2 has become known which describes a clutch for connecting driving shafts in a rotatively fixed manner. The electromagnetic clutch is intended in the non-activated state to enable the rotating connection of a shaft of a motor with the shaft of a loom, while it has to separate the rotation of one of the shafts from the other when being activated. In this way, the synchronous connection between the shafts can also be maintained in the absence of energy. The coupling occurs via an axially movable disc which has end side engagement means.

From JP 2001 248 663 a further embodiment of an electromagnetic clutch is known which also works according to the principle of a disc which is displaceable in axial direction and is provided on both sides with axially acting coupling teeth.

The state of the art includes form fittingly operating, electromagnetically actuatable clutches as disclosed in DE 26 04 380 A1, DE 32 29 192 A1 and U.S. Pat. No. 3,669,231.

Based on the state of the art, the invention is based on the object to improve a clutch of the generic type so that the energy consumption can be significantly lowered.

The solution of the object according to the invention is provided by the features of claim 1.

Advantageous refinements of the invention are the subject matter of claims 2 to 7.

Such a clutch is characterized by a locally fixable coil housing with an integrated electromagnetic coil, a positioning unit which is rotatably supported in the coil housing and is connectable with the driving part and which has an inner, two-stage saw-tooth-like retaining toothing and a saw-tooth-like actuating toothing which is frontally opposed to the retaining toothing, an axially displaceable coupling unit which is actuated under the influence of the electromagnetic coil and a restoring spring force and which has a thrust ring which is rotatably integrated between the retaining toothing and the actuating toothing and includes two saw-tooth-like serrations and a driven flange which can be coupled with the coupling unit via front side crown toothings and can be connected with the driven part.

An important aspect of the invention is the fact that for switching from the open state of the clutch to the closed state and vice versa, only a switching force which acts in one direction in form of an electromagnetic coil is used. The open position as well as the closed position is ensured exclusively by a resilient restoring force, accompanied by form fitting engagement of the meshing toothings. Electric energy is thus only supplied to the clutch for changing the switching states. Such a principle results in a significant energy saving compared to a clutch in which the open and closed positions are also maintained by means of electric energy. Advantageous in this context is also that the clutch does not have a thermal impact on its environment. In addition, the requirements for the new machine guideline for clutches are satisfied. Even after a malfunction or a failure of the energy supply, the clutch remains in the switching state in which it was before the malfunction or the failure. This ensures a risk free operation of the respective driven device.

In the closed position of the clutch, the resilient restoring force ensures that one of the two serrations of the thrust ring which forms a component of the coupling unit is form fittingly connected with a stage (1. stage) of the retaining toothing of the positioning unit. As a result, the coupling unit is also securely coupled with the crown toothing of the driven flange via a front side crown toothing, which flange is connectable with the driven part. The driving force can be properly transmitted from a driving part to the driven flange and with this to the driven part via the positioning unit and the coupling unit.

On the other hand, it is ensured that also in the open position of the clutch, the thrust ring of the coupling unit is securely connected to the other stage of the holding tooting (2. stage) via the same serrations and thereby the crown toothings on the coupling unit and the driven flange are disengaged.

In the switching position of the clutch, the electromagnetic coil is activated against the resilient restoring force and the thrust ring of the coupling unit is connected form fittingly with the actuating toothing of the positioning unit. This motion sequence serves at the same time for limitedly rotating the thrust ring in order to be able to displace it out of the coupling with the one stage of the retaining toothing into the coupling with the other stage, when the electric energy is switched off again and the resilient restoring force comes to bear.

In order to ensure the rotatability of the thrust ring of the coupling unit which is required for coupling the thrust ring on one hand with the actuating toothing and on the other hand with the two-stage retaining toothing, the tooth tips of the two-stage retaining toothing are frontally opposed to the long tooth flanks of the one-stage actuating toothing which essentially extend in circumferential direction, and for coupling the tooth tips of the actuating toothing to the long tooth flanks of the retaining toothing which also extend essentially in circumferential direction. The long tooth flanks of the serration of the thrust ring and the actuating toothing or the retaining toothing can slide upon one another, namely in such a manner that in a switching process no self inhibition between the toothings occurs. This is dependent on the coefficient of friction of the frictional surfaces. The flank angle is therefore preferably in the range of 50 to 85°. The short tooth flanks of the toothings which extend transversely to the circumferential direction merely have the function to limit the radial adjustment of the thrust ring. Because no torque is transferred with the toothings, no tangential force component acts via the coupling during the axial adjustment of the thrust ring, so that due to this relatively steep angle during displacement of the thrust ring no self inhibition is to be expected. Thus, the flank angle of the short tooth flanks should be in the range of about between 0 to 5°.

The securement of the open position and the closed position of the clutch is achieved in that the tooth height of the 1. stage of the retaining toothing is dimensioned as 2:1 relative to the tooth height of the 2. stage, and in that the difference of the two tooth heights roughly corresponds to the tooth height of the crown toothings on the coupling unit and the driven flange. When a serration of the thrust ring is coupled with the 1. stage of the holding tooting, the coupling unit is also properly connected with the driven flange via the crown toothings. However, when the corresponding serration of the thrust ring is connected with the 2. stage of the retaining toothing, the crown toothings of the coupling unit and the driven flange are disengaged, so that no force transmission from the driving part to the driven part is possible.

In an advantageous embodiment, the positioning unit has an adjusting disc with the front side arranged actuating toothing and a retaining disc with the front side retaining toothing which retaining disc is threadingly engagable with the adjusting disc and a hollow shaft by integrating a distance bushing. Such a measure allows not only an unproblematic production of the different components but also their easy assembly to the clutch. The distance bushing serves then at the same time as bearing of the thrust ring.

In addition, it is useful that the coupling unit is formed by the inner thrust ring, a circumferential tooth gear with front side crown toothing on one end and a radially inwards oriented sliding toothing which interacts with a outside counter toothing on the positioning unit on the other end, an anchoring disc and a spring body disc, wherein the thrust ring is slidingly guided in an inner groove of the anchor and/or spring body disc with a circumferential web. Preferably, the groove is provided in the spring body disc.

The sliding toothing on the gear rim together with the counter toothing on the positioning unit secures the proper axial sliding of the coupling unit relative to the positioning unit for the purpose of coupling the serration of the thrust ring on one hand with the retaining toothing and on the other hand with the actuating toothing. The hollow shaft of the positioning unit is configured so that a groove which faces away from the coupling unit and toward the driving part can be incorporated into the electromagnetic coil and in this way accommodated in a protected manner.

According to the invention, it is particularly advantageous, that the resilient restoring force has spring body packets which have disc springs and are pre-tensioned against the retaining disc. For example, three disc springs can be provided on the circumference of the clutch respectively offset by 120°. This purpose is served by stepped pins which are turned into the retaining disc. The anchor disc then serves for the interaction with the electromagnetic coil.

A proper coupling of the coupling unit via its circumferential gear rim with the driven flange is ensured in that the crown toothings on the coupling unit and on the driven flange have a trapeze shaped cross section.

In the following, the invention is explained in more detail by way of exemplary embodiments shown in the drawings. It is shown in:

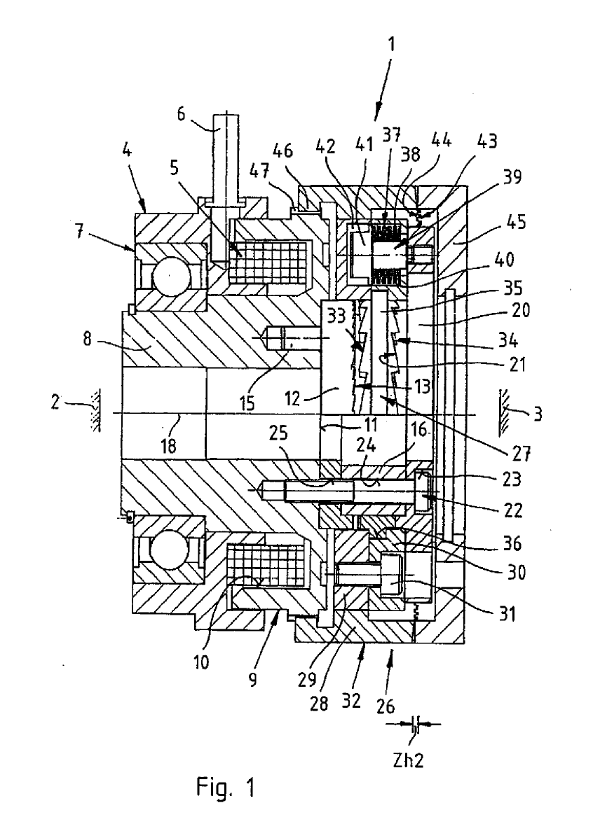

FIG. 1 a clutch in a schematic, vertical longitudinal section

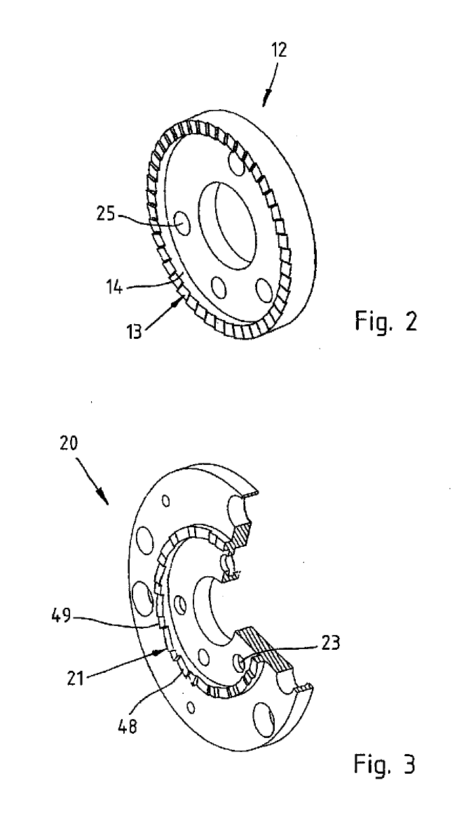

FIG. 2 in a schematic perspective an adjusting disc with actuating toothing;

FIG. 3 in a schematic perspective view, partial cut, a retaining disc with retaining toothing;

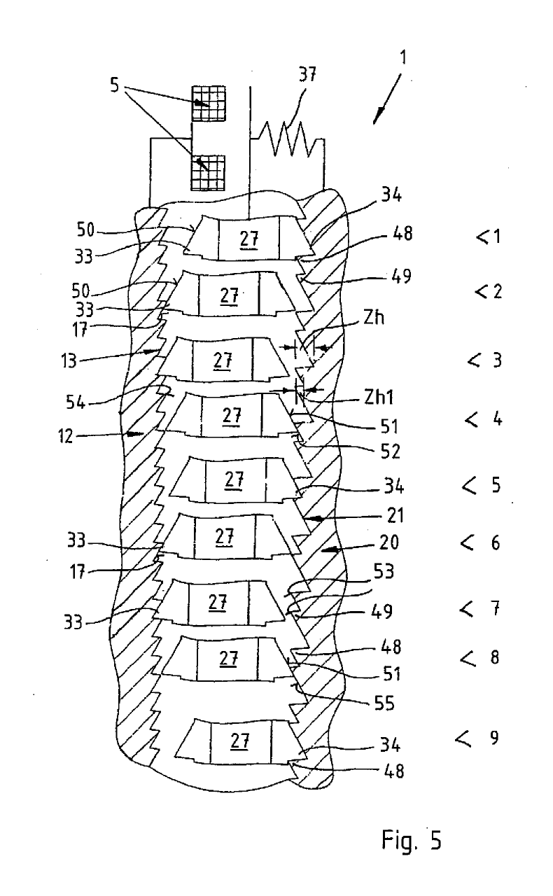

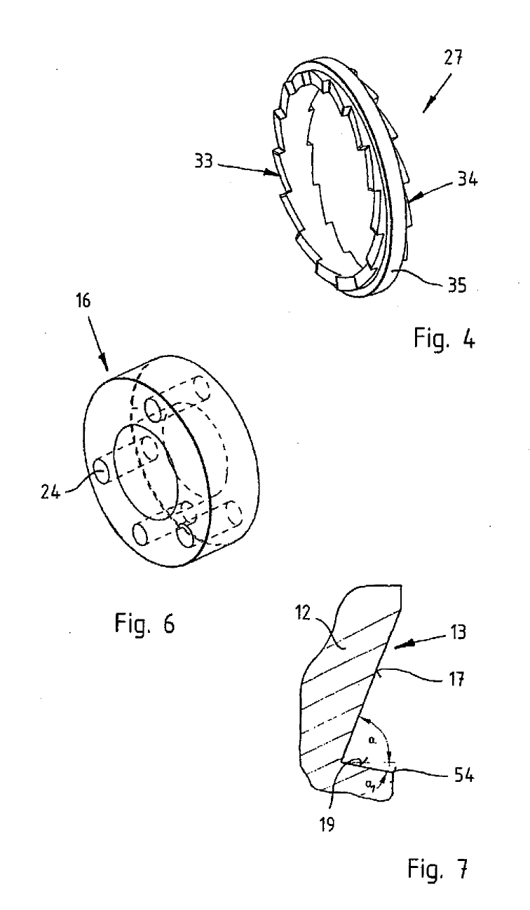

FIG. 4 in a schematic perspective view a thrust ring;

FIG. 5 in a sequential diagram of diverse coupling positions of the clutch;

FIG. 6 in a schematic perspective view a distance bushing and

FIG. 7 in an enlarged schematic representation, a section from the adjusting toothing of the adjusting disc.

In FIG. 1, a clutch is designated with 1, as it is for example used in a rotating drive train between an only schematically indicated driving part 2 in the form of a not further shown driving machine and an also only schematically indicated driven part in the form of an also not further shown working machine.

The clutch 1 includes a positionally fixable coil housing 4 with an integrated electromagnetic coil 5. The electromagnetic coil 5 is supplied with electric energy via a radially extending line 6.

In the coil housing 4, a hollow shaft 8 as component of a positioning unit 9 is supported for rotation about a longitudinal axis 18 by integrating a ball bearing 7. The hollow shaft 8 has a groove 10 which is open toward the direction of the driving part 2, with the electromagnetic coil 5 engaging in the groove 10.

On the recessed front side 11 of the hollow shaft 8 which front side 11 faces away from the driving part 2, a pot-shaped actuating disc 12 with a front side saw-tooth-like actuating toothing 13 is fixed on the axially protruding border 14 by means of pins 15 (cf. FIG. 2). The actuating toothing 13 is shown in more detail in FIG. 7. It includes long tooth flanks 17 which essentially extend in circumferential direction and short tooth flanks 19 which essentially extend parallel to the longitudinal axis 18. The flank angle α of the long tooth flanks 17 can be between 50° and 85° and the flank angle α₁ of the short tooth flanks can be between 0° and 5°.

The actuating disc 12 is spaced apart (cf. FIG. 3) from a retaining disc 20 having a two-stage, saw-tooth-like retaining toothing 21 which is frontally opposed to the actuating toothing 13 of the adjusting disc 12 by means of a distance bushing 16 (cf. FIG. 6). Retaining disc 20, distance bushing 16 and adjusting disc 12 are securely connected with the hollow shaft 8 via multiple threaded bolts 22 which are distributed on the circumference. For this, correspondingly matching bores 23, 24, 25 are provided in the distance bushing 16 and in the adjusting disc 12.

Between the adjusting disc 12 and the retaining disc 20 and on the circumferential side of these discs 12, 20, a coupling unit 26 is located which is formed by a circumferential gear rim 28, an anchor disc 29, and a spring body disc 30. Anchor disc 29, spring body disc 30 and gear rim 28 are connected to one another via threaded bolts 31 and are pinned together in a not further shown manner so as to form an anchor component 32.

The inner thrust ring 27 has two saw-tooth-like serrations 33, 34 of which a first serration 33 interacts with the actuating toothing 13 on the actuating disc 12 and the other second serration 34 interacts with the two-stage retaining toothing 21 on the retaining disc 20.

On the circumference of the thrust ring 27, a web is located which is guided in a groove 36 of the spring body disc 30.

The spring body disc 30 serves for receiving three spring body packets 37 which are evenly offset to one another on the circumference. They are formed by disc springs 38 which are each pre-tensionable by means of a stepped bolt 39, which is turned into the retaining disc 20. The spring body packets 37 are inserted into recesses 40 of the spring body disc 30. The head 41 of the stepped bolt 39 is located in recesses 42 of the anchor disc 29.

The circumferential gear rim 28 of the coupling unit 26 has on one end a front side crown toothing 43 which, like a front side crown toothing 44 on a driven flange 45 which is connected to the driven part 3, has a trapeze-shaped cross section. On the other end, the gear rim 28 has an inward oriented sliding toothing 46, which interacts with an outside counter toothing 47 on the hollow shaft 8.

In the following, the functioning of the clutch 1 is explained by way of FIG. 5. The thrust ring 27, which is shown in a sectional representation is illustrated in diverse operating states. These operating states of the thrust ring 27 are intended to simulate the switching processes between the open-state and closed-state positions. The Figure is to be understood as a rolling off of the circumference of the thrust ring 27, retaining disc 20 and adjusting disc 12.

The two-stage retaining toothing 21 on the retaining disc 20 is arranged so that the ratio between the tooth height Zh of the first stage 48 of the retaining toothing 21 and the tooth height Zh1 of the second stage 49 is about 2:1, wherein the difference between the two tooth heights Zh and Zh1 approximately corresponds to the tooth height Zh2 of the crown toothings 43, 44 on the coupling unit 26 and the driven flange 45 (cf. FIG. 1).

Important within this context is that the tooth tips 53 of the retaining toothing 21 are frontally opposed to the long tooth flanks 17 of the actuating toothing 13 and the tooth tips 54 of the actuating toothing are frontally opposed to the long tooth flanks 52, 55 of the retaining toothing 21.

In the closed position of the clutch 1 (state<1), the thrust ring 27 is form fittingly coupled with the first stage 48 of the retaining toothing 21 via its serration 34. This is exclusively attained via a resilient restoring force (spring body packets 37). The electromagnetic coil 5 is switched off.

After activating the electromagnetic coil 5, the restoring force of the spring body packets 37 is overcome (state<2) and the thrust ring 27 is moved in, the direction toward the actuating disc 12 via the coupling unit 26, wherein the outer tooth flanks 50 of the serration 33 of the thrust ring 27 are now coming to lie against the long tooth flanks 17 of the actuating toothing 13. As a result of these helical toothings 50, 17, the thrust ring 27 rotates in circumferential direction until it is form fittingly connected with the actuating toothing 13 on the actuating disc 12 via its serration 33 according to the state<3.

When the energy supply to the electromagnetic coil 5 is now interrupted again, the spring body packets 37 pull the thrust ring 27 back in the direction toward the retaining disc 20 so that the tooth flanks 51 of the serration 34 come into contact with the tooth flanks 52 of the second stage 49 of the retaining toothing 21, corresponding to state<4 and subsequently, the serration 34 is form fittingly coupled with the second stage 49 of the retaining toothing 21 corresponding to state<5. Because of the different tooth heights Zh and Zh1 of the retaining toothing 21, the spring body packets 37 alone, without energy supply to the electromagnetic coil 5, ensure in state<5 that the clutch 1 is in the open position. The crown toothings 43, 44 are not in engagement.

When the clutch 1 is to be closed again, the electromagnetic coil 5 is activated, wherein the thrust ring 27 is pulled against the restoring force of the spring body packets 37 in the direction towards the actuating disc 12, until the serration 33 on the thrust ring 27 comes into contact with the long tooth flanks 17 of the serration 13 on the actuating disc (state<6). The oblique surfaces of the tooth flanks 17 of the actuating toothing 13 and 50 of the serration 33 cause the thrust ring 27 to rotate until according to state<7 the serration 33 of the thrust ring 27 is properly form fittingly coupled with the actuating toothing 13.

Supply of electric energy to the electromagnetic coil 5 can now be suspended again. According to state<8, the spring body packets 37 pull the thrust ring 27 back in the direction toward the retaining disc 20, wherein the tooth flanks 51 of the serration 34 of the thrust ring 27 come now into contact with the long tooth flanks 55 of the first stage 48 of the retaining toothing 21 and due to the oblique position of the tooth flanks 51, 55, the thrust ring 27 is rotated in circumferential direction until it is securely form fittingly coupled with the retaining disc 20 according to state<9. The clutch 1 is closed. The crown toothings 43, 44 on the coupling unit 26 and on the driven flange 45 engage with each other for the transmission of force. This state is exclusively brought about by the spring body packets 37. Energy supply to the electromagnetic coil 5 is not required.

### REFERENCE SIGNS

1—clutch
2—driving part first serration on 27
3—driven part second serration on 27
4—coil housing web on 27
5—electromagnetic coil
6—supply line
7—ball bearing
8—hollow shaft
9—positioning unit
10—groove in 8 for 5
11—inner front side of 8
12—actuating disc
13—actuating toothing on 12
14—border of 12
15—pin
16—distance bushing
17—long tooth flanks of 13
18—longitudinal axis of 1
19—short tooth flanks of 13
20—retaining disc
21—retaining toothing on 20
22—threaded bolt
23—bores in 20
24—bores in 16
25—bores in 12
26—coupling unit
27—thrust ring
28—gear rim
29—anchor disc
30—spring body disc
31—threaded bolt
32—anchor component
33—first serration on 27
34—second serration on 27
35—web on 27
36—groove in 30
37—spring body packet
38—disc spring
39—stepped bolt
40—recesses in 30
41—head of 39
42—recesses in 29
43—crown toothing on 28
44—crown toothing on 45
45—driven flange
46—sliding toothing on 28
47—counter toothing on 8
48—first stage of 21
49—second stage of 21
50—Tooth flanks of 33
51—Tooth flanks of 34
52—Tooth flanks of 49
53—Tooth tips of 21
54—Tooth tips of 13
55—Tooth flanks of 48
α—flank angle of 17
α₁ flank angle of 19
Zh—tooth height of 48
Zh1—tooth height of 49
Zh2—tooth height of 43, 44

1.-7. (canceled)

8. A clutch which is incorporable in a rotating driving train between a driving part and a driven part, comprising:
a locally fixable coil housing including an integrated electromagnetic coil;
a positioning unit rotatably supported in the housing and being connectable with the driving part, said positioning unit including an inner two-stage saw-tooth-like retaining toothing and a saw tooth like actuating toothing, frontally opposed to the retaining toothing;
an axially displaceable coupling unit actuated under the influence of the electromagnetic coil and a resilient restoring force and which has a thrust ring rotatably integrated between the retaining toothing and the actuating toothing and has two saw-tooth-like serrations; and
a driven flange coupleable with the coupling unit via front side crown toothings and connectable with the driven part.

9. The clutch of claim 8, wherein tooth tips of the two-stage retaining toothing are frontally opposed to tooth flanks of the one-stage actuating toothing, said tooth flanks of the one-stage actuating toothing essentially extending in a circumferential direction, and wherein tooth tips of the actuating toothing are frontally opposed to tooth flanks of the retaining toothing, said tooth flanks of the retaining toothing essentially extending in the circumferential direction.

10. The clutch of claim 8, wherein a ratio between a tooth height of a first stage of the retaining toothing and a tooth height of a second stage of the retaining toothing is about 2:1 and a difference between the tooth height of the first stage and the tooth height of the second stage substantially corresponds to a tooth height of the crown toothings on the coupling unit and on the driven flange.

11. The clutch of claim 8, wherein the positioning unit further comprises an actuating disc and a retaining disc, said actuating toothing being arranged on a front side of the actuating disc, said retaining toothing being arranged on a front side of the retaining disc, and wherein the retaining disc is threadingly engageable with the actuating disc and a hollow shaft by incorporating a distance bushing.

12. The clutch of claim 8, wherein the coupling unit further comprises a circumferential gear rim, an anchor disc and a spring body disc, wherein the crown toothing is provided on an end of the gear rim and a radially inward oriented sliding toothing provided on another end of the gear rim, said sliding toothing interacting with an outer counter tooting provided on the positioning unit, and wherein the thrust ring has a circumferential web and is slidingly guided with the circumferential web in an inner groove of the spring body disc and/or the anchor disc.

13. The clutch of claim 8, wherein the resilient restoring force comprises spring body packets including disc springs, said spring body packets being pre-tensioned against the retaining disc.

14. The clutch of claim 8, wherein the crown toothings on the coupling unit and on the driven flange have a trapeze-shaped cross section.
